(19) United States
(12) Patent Application Publication
(10) Pub. No.: US 2026/0239171 A1
(43) Pub. Date: Aug. 13, 2026

(54) WTRU Determined NAS Configuration

(71) Applicant: InterDigital Patent Holdings, Inc., Wilmington, DE (US)

(72) Inventors: Michael Starsinic, Newtown, PA (US); Faris Alfarhan, Montreal (CA); Oumer Teyeb, Montreal (CA); Yugeswar Deenoo Narayanan Thangaraj, Chalfont, PA (US); Ghyslain Pelletier, Montreal (CA); Diana Pani, Montreal (CA); Samir Ferdi, Kirkland (CA); Saad Ahmad, Montreal (CA); Anuj Sethi, Ottawa (CA); Taimoor Abbas, Sainte-Julie (CA); Ulises Olvera-Hernandez, Saint-Lazare (CA); Dylan Watts, Montreal (CA)

(73) Assignee: InterDigital Patent Holdings, Inc., Wilmington, DE (US)

(21) Appl. No.: 19/049,727

(22) Filed: Feb. 10, 2025

(51) Int. Cl. H04W 48/08; H04W 60/00

(52) U.S. Cl. CPC H04W 48/08; H04W 60/00

(57) ABSTRACT

A method may be implemented by a wireless transmit/receive unit (WTRU), including sending a first message to the network indicating that the WTRU can determine a value of a Non-Access Stratum (NAS) layer parameter. Configuration information may be received from a network, indicating whether the WTRU is permitted to determine the value of the NAS layer parameter and whether the WTRU is to report the value to the network prior to utilizing the value. The value may be determined based on the at least one condition associated with the WTRU. The value of the NAS layer parameter may be a timer value. The value of the NAS layer parameter may be applied to a NAS procedure performed by the WTRU. A second message may be sent to the network, comprising an indication of the value of the NAS layer parameter or an indication that the WTRU has applied the value.

### BACKGROUND

A WTRU may utilize the Non-Access Stratum (NAS) layer for various functions. The NAS protocol may support mobility management procedures between the WTRU and the network, session management procedures between the WTRU and the network, and/or the transport of containers between the WTRU and the network. The containers may relate to Short Message Service (SMS), Location and Positioning Protocol (LPP), Sidelink Positioning Protocol (SLPP), Location Services (LCS), User Plane Positioning Connection Management Information (UPP-CMI), WTRU policies, Steering of Roaming (SOR), and/or WTRU parameters.

NAS-mobility management (MM) may refer to NAS protocol messages and/or procedures that may be utilized for mobility management. In a 5G System, NAS-MM messages may be sent to an AMF. The AMF may be an example of a network function that may provide access and/or mobility management functionality. NAS-session management (SM) may refer to NAS protocol messages and/or procedures that may be utilized for session management. In a 5G System, NAS-SM messages may be sent to a session management function (SMF). The SMF may be an example of a network function that may provide session management functionality.

### SUMMARY

A wireless transmit/receive unit (WTRU) may include a processor. The processor may be configured to send a first message to the network. The first message may indicate that the WTRU is capable of determining the value of at least one Non-Access Stratum (NAS) layer parameter. The processor may be configured to receive configuration information from a network. The configuration information may indicate whether the WTRU is permitted to determine a value of the NAS layer parameter and whether the WTRU is to report the value of the NAS layer parameter to the network prior to utilizing the value of the NAS layer parameter. The processor may be configured to determine, based on at least one condition associated with the WTRU, the value of the NAS layer parameter. The value of the NAS layer parameter may be a timer value. The value of the NAS layer parameter may be applied to at least one NAS procedure performed by the WTRU. A second message may be sent to the network. The second message may include one or more of an indication of the value of the NAS layer parameter or an indication that the WTRU has applied the value of the NAS layer parameter.

The processor may be configured to utilize the value of the NAS layer parameter in one or more of a NAS mobility management procedure, a NAS session management procedure, or a NAS disaster roaming procedure.

The value of the NAS layer parameter may include one or more of a periodic registration timer, a back-off timer, or a Protocol Data Unit (PDU) session establishment retransmission timer.

The processor may be configured to send a third message to the network prior to applying the value of the NAS layer parameter, wherein the third message indicates the value of the NAS layer parameter.

The processor may be configured to receive a response message from the network before applying the value of the NAS layer parameter. The response message may include an indication of whether the WTRU is permitted to apply the value of the NAS layer parameter.

The processor may be configured to determine the value of the NAS layer parameter using an Artificial Intelligence/Machine Learning (AI/ML) model.

The processor may be configured to determine AI/ML model inputs prior to determining the value of the NAS layer parameter, wherein the AI/ML model inputs comprise at least one of WTRU speed, WTRU location, historical access to high-priority services, or network conditions.

The configuration information may include an indication of how the WTRU is permitted to modify the value of the NAS layer parameter. The indication of how the WTRU is permitted to modify the value of the NAS layer parameter may include an indication of a maximum allowable percentage change from a network-configured value of the NAS layer parameter.

The at least one condition may include one or more of a WTRU speed, a WTRU location, historical access to high-priority services, or network conditions.

The processor may be configured to determine to enter an idle mode based on the value of the NAS layer parameter and to initiate a registration update procedure upon exiting the idle mode.

A method may be implemented by a wireless transmit/receive unit (WTRU), including sending a first message to a network. The first message may indicate that the WTRU is capable of determining a value of at least one Non-Access Stratum (NAS) layer parameter. Configuration information may be received from the network. The configuration information may indicate whether the WTRU is permitted to determine a value of the NAS layer parameter and whether the WTRU is to report the value of the NAS layer parameter to the network prior to utilizing the value of the NAS layer parameter. A value of the NAS layer parameter may be determined based on the at least one condition associated with the WTRU. The value of the NAS layer parameter may be a timer value. The value of the NAS layer parameter may be applied to at least one NAS procedure performed by the WTRU. A second message may be sent to the network. The second message may comprise at least one of an indication of the value of the NAS layer parameter or an indication that the WTRU has applied the value of the NAS layer parameter.

The method may include utilizing the value of the NAS layer parameter in one or more of a NAS mobility management procedure, an NAS session management procedure, or a NAS disaster roaming procedure.

The value of the NAS layer parameter may include one or more of a periodic registration timer, a back-off timer, or a Protocol Data Unit (PDU) session establishment retransmission timer.

The method may include sending a third message to the network prior to applying the value of the NAS layer parameter, wherein the third message indicates the value of the NAS layer parameter.

The method may include receiving a response message from the network before applying the value of the NAS layer parameter, wherein the response message comprises an indication of whether the WTRU is permitted to apply the value of the NAS layer parameter.

The method may include determining the value of the NAS layer parameter using an Artificial Intelligence/Machine Learning (AI/ML) model.

The method may include determining AI/ML model inputs prior to determining the value of the NAS layer parameter, wherein the AI/ML model inputs comprise at least one of WTRU speed, WTRU location, historical access to high-priority services, or network conditions.

The configuration information may include an indication of how the WTRU is permitted to modify the value of the NAS layer parameter. The indication of how the WTRU is permitted to modify the value of the NAS layer parameter may include an indication of a maximum allowable percentage change from a network-configured value of the NAS layer parameter.

The at least one condition may include one or more of a WTRU speed, a WTRU location, historical access to high-priority services, or network conditions.

The method may include determining to enter an idle mode based on the value of the NAS layer parameter and initiating a registration update procedure upon exiting the idle mode.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example method for a WTRU to determine a value of one or more NAS layer parameters.

FIG. 3 is a diagram illustrating an example method for coordination between a WTRU and a network for feature activation using a proactive approach.

FIG. 4 is a diagram illustrating an example method for coordination between a WTRU and a network for feature activation using a reactive approach.

FIG. 5 is a diagram illustrating an example method for determining when to use WTRU-determined values of one or more NAS layer parameters.

FIG. 6 is a diagram illustrating an example method for using an AI/ML model to determine a periodic registration timer value.

### DETAILED DESCRIPTION

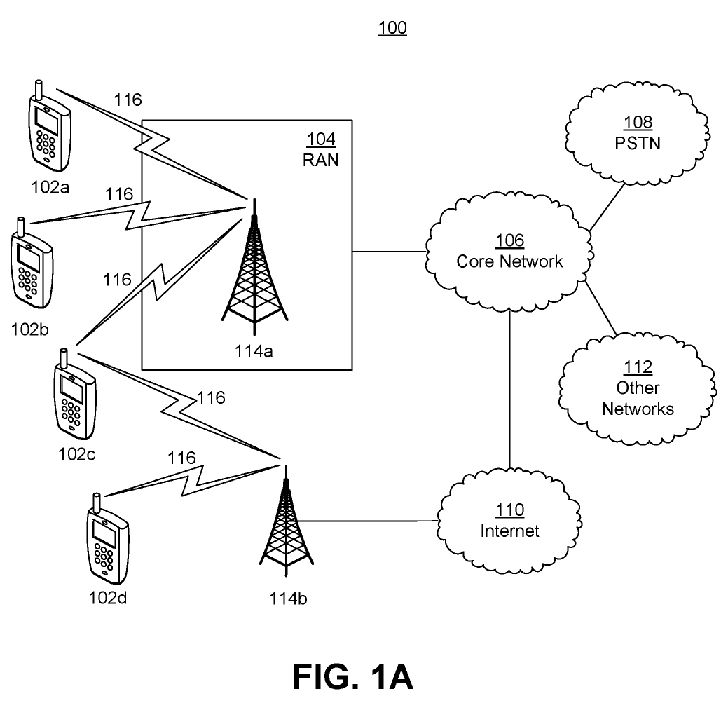

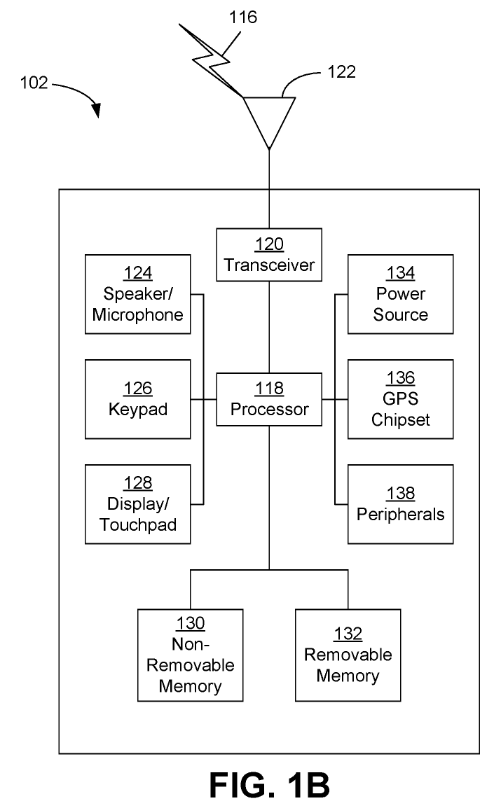

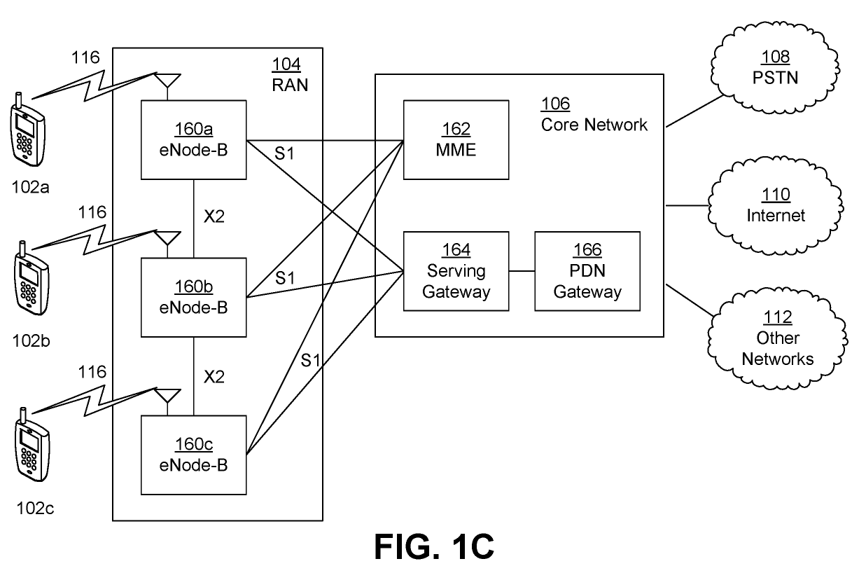

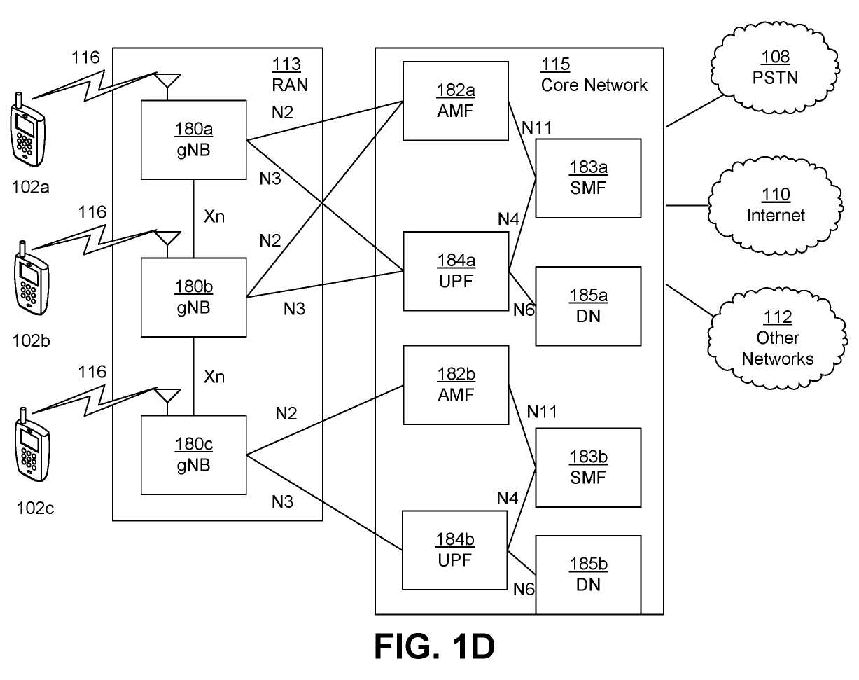

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102cmay implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a,102b,102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a,183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In examples, NAS procedures may be triggered and/or blocked based on the configuration of timers. For example, registration update may be a NAS mobility management procedure. The WTRU may utilize a timer to determine when to perform a registration update procedure. The timer may be configured by the network to control how often the WTRU may perform the registration update procedure. A small timer value may result in the WTRU performing the registration update procedure more frequently and may also result in the network determining the WTRU’s location with more accuracy. A large timer value may result in the WTRU performing the registration update procedure less frequently and may also result in the network determining the WTRU’s location with less accuracy.

A Protocol Data Unit (PDU) session establishment may be a NAS session management procedure. During a congestion event in the network, the network may reject a PDU session establishment request from the WTRU and may provide a back-off timer to the WTRU. The value of the back-off timer may be utilized by the WTRU to determine when the WTRU may attempt to send the PDU session establishment request again. A small back-off timer value may result in the WTRU attempting to initiate the PDU session establishment procedure again soon and may also result in reducing the delay between the time that the WTRU determines that it needs to establish the PDU session and the time when the PDU session is available to carry the WTRU’s application layer traffic. A large back-off timer value may result in the WTRU attempting to initiate the PDU session establishment procedure again after a longer delay and may also result in increasing the delay between the time that the WTRU determines that it needs to establish the PDU session and the time when the PDU session is available to carry the WTRU’s application layer traffic.

An example of an NAS procedure that may be controlled based on network-configured timers may be the registration procedure. In the context of disaster roaming with minimization of service interruption (MINT), the WTRU may be configured by the serving network, prior to and/or during disaster roaming, with wait range parameters and/or return wait range parameters. These registration wait range parameters may include minimum and/or maximum wait times that may be utilized to help spread out the arrival of the WTRU in the PLMN providing disaster roaming service and/or return to the regular serving PLMN when the disaster condition no longer applies. An example of a NAS procedure during disaster roaming may include utilizing disaster roaming WTRUs, which may hold initiating a registration for a timer within that wait range window to mitigate potential signaling overload due to massive registrations by disaster roaming WTRUs.

The configuration of some NAS layer parameters may interact with and/or impact Radio Access Network (RAN) layer parameters. Similarly, the configuration of some RAN layer parameters may interact with and/or impact NAS layer parameters. The NAS layer active timer may be an example of a NAS layer parameter. The extended Discontinuous Reception (eDRX) cycle length may be an example of a RAN layer parameter. The eDRX cycle length of a WTRU may be configured such that multiple paging occasions may take place while the WTRU’s active timer is running. Thus, the active timer may be an example of a NAS layer parameter that may influence RAN layer parameters, and the eDRX cycle length may be an example of a RAN layer parameter that may influence NAS layer behavior.

A Wireless Transmit/Receive Unit (WTRU) may determine how to configure its Non-Access Stratum (NAS) layer (e.g., determine what timer values to configure in the NAS layer). The WTRU may determine the NAS layer configuration based on conditions at the WTRU and the needs of the user of the WTRU. Conditions at the WTRU may include WTRU speed and WTRU location. The needs of the user of the WTRU may include applications that are actively running in the WTRU and/or applications that are anticipated to run in the WTRU. Allowing the WTRU to determine the NAS layer configuration may present advantages over an approach in which the network configures the NAS layer of the WTRU (e.g., approaches in which the network configures the WTRU with values that must be used in NAS layer timers).

The WTRU and the network may perform procedures that allow the WTRU to indicate to the network that the WTRU may independently determine NAS layer values and apply the determined NAS layer values in NAS procedures that require such values. The network may indicate to the WTRU whether the WTRU may use the feature.

Once the WTRU is granted permission to independently determine certain NAS layer parameter values, the WTRU may determine the values of one or more NAS layer parameters, referred to interchangeably herein with NAS layer parameter values, may provide information to the network regarding the WTRU-determined values, and utilize the determined values of one or more NAS layer parameters in NAS layer procedures.

The terms "Idle State" and "Idle Mode" may be used interchangeably. The terms "periodic registration procedure" and "registration update procedure" may also be used interchangeably and may refer to a registration procedure that the WTRU may initiate to inform the network that the WTRU remains available in the network.

Examples described herein that relate to an Access and Mobility Function (AMF) may be applied to other network functions and/or services. For example, such ideas may be applied to a mobility management and/or access function or service in a Sixth Generation (6G) network. Similarly, ideas described herein that relate to a Session Management Function (SMF) may be applied to other network functions and/or services. For example, such ideas may be applied to a session management function in a 6G network and/or a session management service in a 6G network.

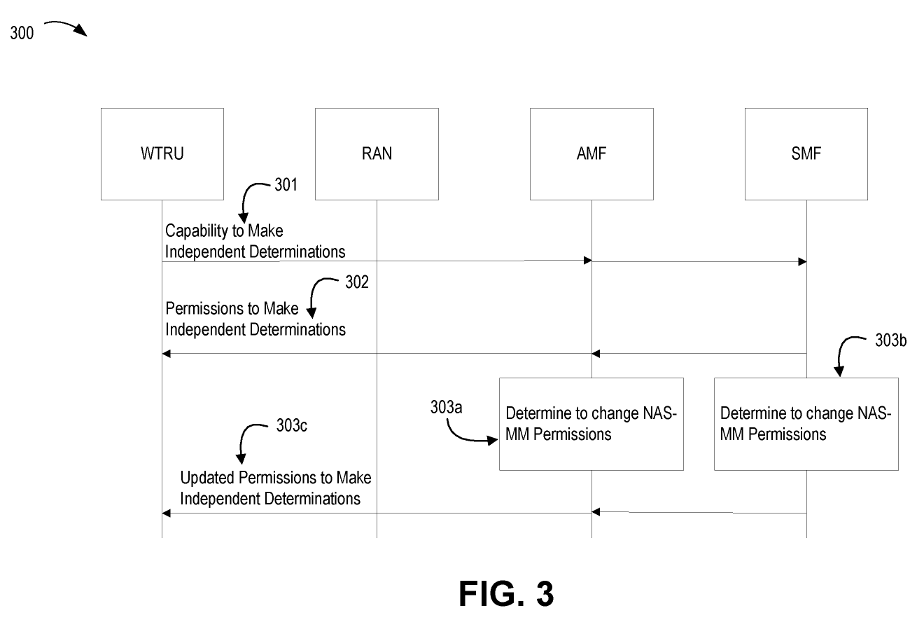

In a Fifth Generation (5G) network, NAS-Session Management (NAS-SM) messages between the WTRU and the SMF may be sent via the AMF. In some networks, the WTRU may communicate directly with an SMF, and the ideas described herein may be applied to such networks. For example, referring to FIG. 3, at 301, the WTRU may send a first message to the AMF and a second message to the SMF. Referring to FIG. 3, at 302, the WTRU may receive a third message from the AMF and a fourth message from the SMF.

The "user of the WTRU" may refer to a human user of the WTRU and/or applications that generate traffic for transmission by the WTRU and/or applications that require the WTRU to receive traffic.

Examples of a values of a NAS layer parameter may include back-off timers, periodic registration timers, mobile reachable timers, non-Third Generation Partnership Project (3GPP) de-registration timers, lower bound timers, and NAS retransmission timers.

The ability of a WTRU to determine NAS layer parameter values may be considered a feature of the WTRU.

Examples described herein may involve the WTRU "using an Artificial Intelligence/Machine Learning (AI/ML) model" and/or "running an AI/ML model." The terms "using an AI/ML model" and/or "running an AI/ML model" may refer to an AI agent in a WTRU collecting input data, processing the input data based on the AI/ML model, and generating an output. In the context described herein, the output may be a NAS parameter value such as a timer value, a Default Configured Network Slice Selection Assistance Information (NSSAI), and/or a list of Public Land Mobile Networks (PLMNs) to be used for disaster conditions.

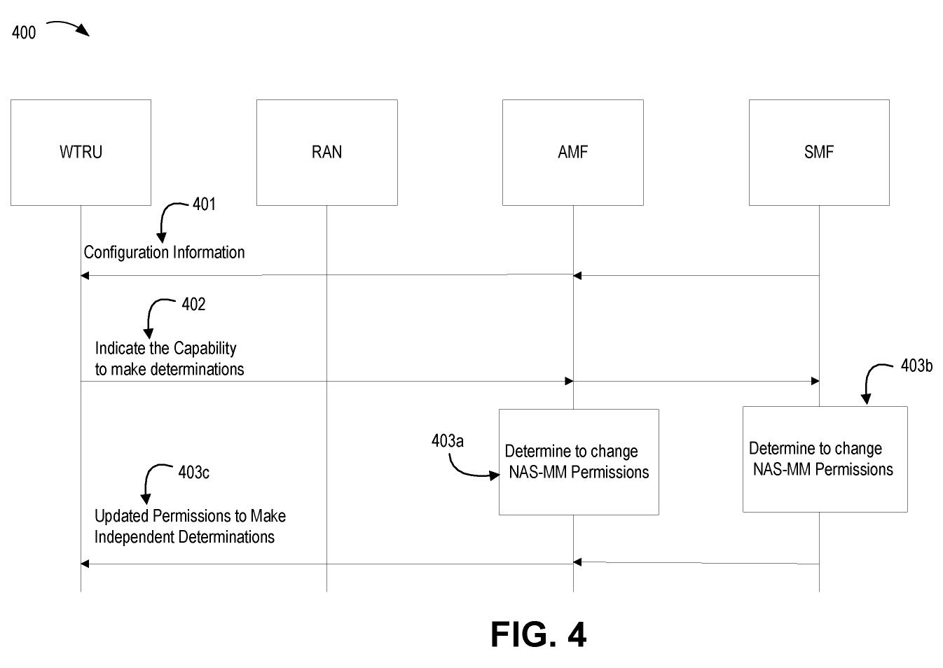

A WTRU may perform a series of steps to determine a NAS layer configuration. The NAS message may indicate to the network that the WTRU is capable of determining an NAS layer parameter, as described in further detail herein below with reference to FIG. 3, at 301, and/or FIG. 4, at 402. This NAS message may be sent to a mobility management function, and the NAS layer parameter may be a NAS-MM timer. This NAS message may be sent to a session management function, and the NAS layer parameter may be a NAS-SM timer. The message may indicate the conditions under which the WTRU would like to determine a NAS layer parameter value.

A NAS message may be received from the network, as described in further detail herein below with reference to FIG. 3, at 302 and/or 303c, and/or FIG. 4, at 403c. The message may indicate that the WTRU is permitted to determine the NAS layer parameter. This NAS message may be received from a mobility management function. This NAS message may be received from a session management function. The message may indicate whether the WTRU is permitted to autonomously use the NAS layer parameter value when the WTRU determines the value, whether the WTRU needs to report the value to the network, and whether the WTRU needs permission from the network before using a newly determined value. The message may indicate whether there are limitations on the degree to which the WTRU may change the NAS layer parameter value.

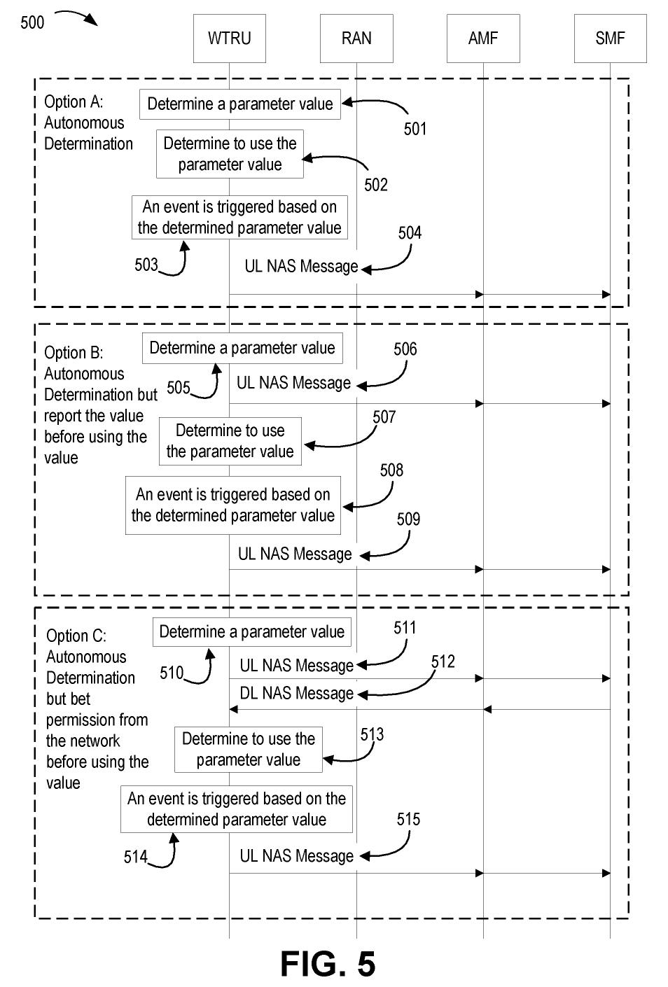

The WTRU may determine the NAS layer parameter value, as described in further detail herein below with reference to FIG. 5, at 501, 505, and/or 510. The determination may be based on using an AI/ML model. The NAS layer parameter may be a timer value.

An event may be triggered based on the NAS layer parameter, as described in further detail below with reference to FIG. 5, at 503, 508, and/or 514. The event may be the expiration of a timer.

The WTRU may send a NAS message to the network to provide the determined NAS layer parameter to the network, as described in further detail herein below with reference to FIG. 5, at 506 and/or 511, under option B and/or C.

A NAS message may be received from the network that indicates that the WTRU is permitted to use the WTRU-determined NAS layer parameter value, as described in further detail herein below with reference to FIG. 5, at 512, under option C.

The WTRU may send a NAS message to the network based on detection of the event, as described in further detail herein below with reference to FIG. 5, at 504, 509, and/or 515. The message may include the value of the NAS layer parameter.

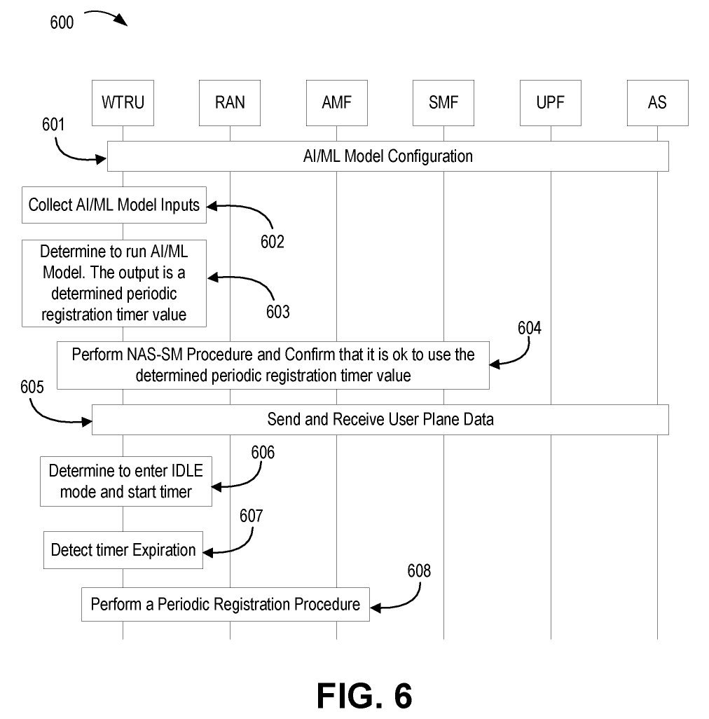

In examples, the WTRU may be configured to determine when to trigger a registration update procedure. The WTRU may be configured with an AI/ML model and information that indicates that the AI/ML model is associated with one or more PLMN IDs, default parameter values, and default parameter ranges, as described in further detail herein below with reference to FIG. 6, at 601. The AI/ML model and information may be received in a NAS message, a Radio Resource Control (RRC) message, and/or an application layer message.

The WTRU may collect AI/ML model inputs, as described in further detail herein below with reference to FIG. 6, at 602. Examples of input values may include WTRU speed information, WTRU trajectory information, information about the WTRU’s history accessing high-priority services, and information related to network conditions. The information related to network conditions may include information that is broadcast by the network.

The WTRU may determine to run the AI/ML model, run the AI/ML model, and obtain a determined periodic registration timer value from the AI/ML model, as described in further detail herein below with reference to FIG. 6, at 603. The determination to run the AI/ML model may be based on detecting a change in the AI/ML model inputs.

The WTRU may perform a NAS procedure with the network to provide the determined periodic registration timer to the network, as described in further detail herein below with reference to FIG. 6, at 604. The WTRU may also receive an indication that the WTRU is permitted to use the determined periodic registration timer.

The WTRU may determine to enter an idle mode, as described in further detail herein below with reference to FIG. 6, at 605.

The WTRU may stay in the idle mode for a duration that is based on the determined periodic registration timer value, as described in further detail herein below with reference to FIG. 6, at 606 and/or 607.

The WTRU may determine to exit the idle mode and initiate a registration update procedure, as described in further detail herein below with reference to FIG. 6, at 608.

Configuration of NAS timers by the network may involve the network making determinations regarding how to set timers in a way that accounts for both network operations and WTRU functionality. For example, timers may be set in a way that does not cause the WTRU to generate unnecessary signaling while also ensuring that the WTRU does not experience unnecessary delays in obtaining service. The current design of a 5G system may not enable network nodes that configure NAS timers to reliably predict optimal timer values.

For example, in the case of disaster roaming, it may be assumed that disaster roaming WTRUs select a random time within the wait range window to reduce risks of signaling overload. However, the network-provided wait range may not be specifically adapted to the context of the disaster condition. The disaster condition context may include the disaster roaming PLMN, the PLMN under the disaster condition, time of day, cell coverage in the disaster area, and/or WTRU population density (e.g., urban and/or remote/rural areas). A random selection mechanism by a WTRU may result in the WTRU waiting longer than necessary to regain service from a disaster roaming PLMN and/or a regular PLMN (e.g., due to a large wait range time configured by the network). These situations may be particularly problematic in emergency scenarios (e.g., a natural disaster condition). It may be understood that the wait range mechanism may not always prevent signaling overload conditions (e.g., when the wait range time is short), which is why existing congestion and/or overload mitigation mechanisms at an AMF and/or SMF may still be utilized.

System improvements may enable the WTRU to determine timer values and/or default WTRU parameter values that are better adapted to the needs of a user and/or applications on the WTRU. A WTRU may determine NAS layer parameter values by considering the needs of the user and/or applications on the WTRU and/or the needs and/or conditions of the network.

A WTRU may determine how to configure its NAS layer (e.g., determine what timer values to configure in the NAS layer). The WTRU may determine how to configure the NAS layer based on conditions at the WTRU and the needs of the user of the WTRU. Examples of conditions at the WTRU include the WTRU speed and location. Examples of the needs of the user of the WTRU include what applications are actively running in the WTRU and/or applications that are anticipated to need to run in the WTRU. Allowing the WTRU to determine how to configure its NAS layer presents advantages over an approach in which the network configures the WTRU’s NAS layer (e.g., approaches in which the network configures the WTRU with values that may be used in NAS layer timers).

The WTRU and the network may perform procedures that allow the WTRU to indicate to the network that the WTRU is able to independently determine NAS layer values and allow the network to indicate to the WTRU whether the WTRU is allowed to use the feature. FIG. 3 and FIG. 4 show an example procedure for how the WTRU and the network may coordinate with respect to NAS layer configuration parameters that may be independently determined by the WTRU.

Once the WTRU is granted permission to independently determine certain values of NAS layer parameters, the WTRU may independently determine NAS layer parameters, provide information to the network about the WTRU-determined values, and/or use the determined values of NAS layer parameters in NAS layer procedures. FIG. 5 and FIG. 6 show examples of how the WTRU may determine a NAS layer parameter value and then use the determined value to influence NAS layer behavior.

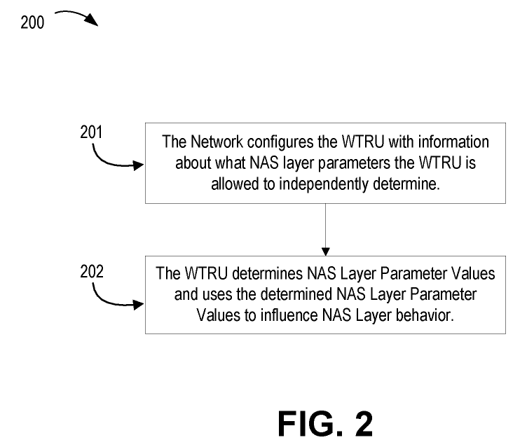

An example of this process is shown in FIG. 2. Referring now to FIG. 2, a method 200 for a WTRU to determine values of NAS layer parameters is illustratively depicted.

At 201, the network may configure the WTRU with information regarding NAS layer parameters that the WTRU may determine independently. At 202, the WTRU may determine values of NAS layer parameters and use the determined values in NAS layer procedures.

A WTRU may determine a NAS layer configuration. A WTRU may coordinate with the network for feature activation. A WTRU may determine values of NAS layer parameters, and coordination between the WTRU and the network may be useful for feature activation. If the WTRU may determine values of NAS layer parameters, it may be particularly useful for the WTRU and the network to coordinate how the feature is used by the WTRU. For example, it may be useful for the WTRU and the network to coordinate values of NAS layer parameters so that both the WTRU and the network are aware of what parameter values are being used, what parameter values may be changed independently by the network, what parameter values may be changed independently by the WTRU, and/or the range of values that may be assigned to a parameter value. For example, it may be particularly useful for the network to be aware of a periodic registration timer value and/or a possible range of values for a periodic registration timer that is maintained in the WTRU so that the network may determine when to begin an implicit de-registration timer.

A WTRU may proactively send an indication to indicate to the network that the WTRU is capable of determining values of NAS layer parameters (e.g., that the WTRU supports the feature of determining values of NAS layer parameters). Values that may be configured in timers that control NAS layer messaging may be examples of values of NAS layer parameters. The WTRU may indicate to the network that the WTRU is capable of determining some values of NAS layer parameters and/or that the WTRU is not capable of determining other values of NAS layer parameters. For example, the WTRU may indicate that it is capable of determining NAS-MM parameter values and that the WTRU is not capable of determining NAS-SM parameter values. The indication from the WTRU to the network may be sent in an uplink (UL) NAS transport message. The WTRU may indicate what NAS-MM parameter values it may determine and/or what NAS-SM parameter values it may determine. Indications of what NAS-SM parameters the WTRU may determine may be carried in the NAS-SM portion of a NAS message.

The network may send a downlink (DL) NAS transport message in response to the UL NAS transport message. The DL NAS transport message may indicate to the WTRU which values of NAS layer parameters the network permits the WTRU to determine. For example, a NAS-MM message may indicate that the WTRU is not permitted to independently determine certain NAS-MM back-off timer values but is permitted to determine a periodic registration timer value. The NAS-SM portion of the message may indicate that the WTRU is not permitted to independently determine certain NAS-SM back-off timer values but is permitted to determine a PDU session establishment request retransmission value (e.g., T3580). For NAS-MM and NAS-SM parameters that the network permits the WTRU to determine, the network may provide the WTRU with parameter ranges and/or default parameter values. The message(s) that indicate to the WTRU that the WTRU is permitted to determine parameter values may also be used to configure the WTRU with parameter ranges and/or default parameter values.

Additionally, and/or alternatively, a response message from the network may indicate that the WTRU is not permitted to determine parameter values. If a request message from the WTRU included determined parameter values, the response message from the network may not indicate whether the WTRU is permitted to use the determined parameter values. The response message from the network may configure the WTRU with parameter values that the WTRU may utilize.

At a later time, the network may determine to send a DL NAS transport message to indicate to the WTRU that the WTRU is permitted to determine parameter values. The WTRU may initially utilize network-configured parameter values and may later determine to use WTRU-determined values based on certain conditions. For example, the WTRU may determine to use WTRU-determined values because the network detects changing network conditions, because the network has determined that the WTRU has been successfully authenticated and/or authorized, because the network has determined that the WTRU may be trusted to determine parameter values, and/or because the network has determined that the WTRU has successfully executed a procedure verifying that the WTRU is capable of determining parameter values.

Referring now to FIG. 3, an example procedure 300 for coordination between the WTRU and the network for feature activation using a proactive approach is illustratively depicted. FIG. 3 shows an example procedure for how the WTRU and the network may coordinate whether the WTRU is permitted to determine parameter values.

At 301, the WTRU may indicate to the network that the WTRU is capable of determining values of NAS layer parameters. In this example, the WTRU may indicate its capability to determine NAS-MM parameters to the AMF and/or its capability to determine NAS-SM parameters to the SMF.

At 302, the AMF may indicate to the WTRU which NAS-MM parameter values the network permits the WTRU to determine, and the SMF may indicate to the WTRU which NAS-SM parameter values the network permits the WTRU to determine. The response from the SMF may be sent to the WTRU via the AMF. The AMF and/or SMF may additionally and/or alternatively indicate to the WTRU that the WTRU is not permitted to determine certain parameter values. The AMF and/or SMF may additionally and/or alternatively send parameter values to the WTRU that the WTRU must use.

At 303, the AMF may indicate to the WTRU which NAS-MM parameter values the network permits the WTRU to determine, and the SMF may indicate to the WTRU which NAS-SM parameter values the network permits the WTRU to determine. The information that is conveyed at 303 may be different from the information conveyed at 302. The WTRU may choose to initially use network-configured parameter values and may later determine to allow the WTRU to use WTRU-determined values.

At 303a, the AMF may determine to change NAS-MM permissions based on one or more conditions. The AMF may make this determination autonomously and/or in response to updated network information.

At 303b, the SMF may determine to change NAS-SM permissions based on one or more conditions. The SMF may make this determination autonomously and/or in response to updated network information.

At 303c, the WTRU may receive a message that includes updated information about what NAS-MM and/or NAS-SM parameters the WTRU is permitted to determine. The updated information may indicate whether the WTRU may make determinations to autonomously modify parameters and/or make determinations to modify parameters in response to updated network information.

Referring now to FIG. 4, an example method 400 for coordination between the WTRU and the network for feature activation using a reactive approach is illustratively depicted. FIG. 4 shows an example procedure for how the WTRU and the network may coordinate whether the WTRU is permitted to determine parameter values.

At 401, the WTRU may receive configuration information from the AMF and/or SMF. The configuration information may include timer configuration information such as a back-off timer value and/or a periodic registration timer value.

At 402, the WTRU may determine to send a message to the network to indicate that the WTRU is capable of determining new parameter values for the configuration information that was received at 401. The WTRU may determine to send this message based on receiving the parameter values at 401 and/or determining that the values received at 401 should be adjusted.

At 403, based on the indication that the WTRU is capable of independently determining parameter values, the AMF and/or SMF may determine to notify the WTRU that the WTRU is permitted to independently determine certain parameter values.

At 403a, based on the indication that the WTRU is capable of independently determining parameter values, the AMF may determine to notify the WTRU that the WTRU is permitted to independently determine certain parameter values.

At 403b, based on the indication that the WTRU is capable of independently determining parameter values, the SMF may determine to notify the WTRU that the WTRU is permitted to independently determine certain parameter values.

At 403c, the WTRU may receive updated permissions from the AMF and/or SMF. The updated permissions may indicate whether the WTRU is permitted to independently determine additional parameter values, whether certain values must remain network-configured, and/or whether the WTRU may modify a previously determined value. The WTRU may then determine to change NAS-MM and/or NAS-SM permissions based on one or more conditions. The WTRU may make this determination autonomously and/or in response to the updated network information that was received in 403c.

There may be limitations on the feature that may be used when the WTRU indicates to the network that it is capable of determining certain parameter values. The WTRU may also indicate information about the conditions under which the WTRU would like to determine parameter values. When the conditions are not met, it may serve as an implicit indication that the WTRU would prefer to use network-configured parameter values. Examples of condition information may include location information (e.g., tracking area, cell identities) and/or times of day. For example, a WTRU may desire to conserve energy during certain times of day and may therefore prefer that the network determine the parameter values.

In examples in which the network indicates to the WTRU that the WTRU is permitted to determine a parameter, the network may send indications to the WTRU that indicate whether the WTRU is allowed to autonomously use the WTRU-determined parameter value, must report the WTRU-determined parameter value to the network before autonomously using the WTRU-determined parameter value, and/or must report the WTRU-determined parameter value to the network and not use the WTRU-determined parameter value until the WTRU receives an indication from the network that the WTRU is permitted to use the WTRU-determined parameter value.

When the WTRU receives an indication that the WTRU is allowed to autonomously use the WTRU-determined parameter value, the WTRU may use the WTRU-determined parameter value (e.g., a timer value) immediately after determining the timer value and/or the next time an event occurs when the timer is needed. When the WTRU receives an indication that it must report the WTRU-determined parameter value to the network before autonomously using the WTRU-determined parameter value, the WTRU may use the WTRU-determined parameter value (e.g., a timer value) after sending an indication to the network that the value has been determined. For example, after sending an indication to the network that the value has been determined, the WTRU may use the value the next time an event occurs when the timer is needed. When the WTRU receives an indication that it must report the WTRU-determined parameter value to the network and not use the WTRU-determined parameter value until the WTRU receives an indication from the network that the WTRU is permitted to use the WTRU-determined parameter value, the WTRU may use the WTRU-determined parameter value (e.g., a timer value) immediately after receiving an indication from the network that the value may be used. For example, after receiving an indication from the network that the value may be used, the WTRU may use the value the next time an event occurs when the timer is needed.

At 302 and 303c of FIG. 3 and/or at 401 and 403c of FIG. 4, the network may indicate to the WTRU whether the WTRU is allowed to autonomously use the WTRU-determined parameter value, must report the WTRU-determined parameter value to the network before autonomously using the WTRU-determined parameter value, and/or must report the WTRU-determined parameter value to the network and not use the WTRU-determined parameter value until the WTRU receives an indication from the network that the WTRU is permitted to use the WTRU-determined parameter value.

Furthermore, when the network indicates to the WTRU that the WTRU is permitted to determine a parameter value (e.g., at 302 and 303c of FIG. 3 and/or at 401 and 403c of FIG. 4), the network may also send information to the WTRU that describes limitations on what parameter values the WTRU is allowed to determine. For example, the network may indicate to the WTRU to what degree the WTRU can change a parameter value (e.g., the network may indicate to the WTRU that a timer value cannot be increased more than 20% from its current value), how often the WTRU can change a parameter value, how long the WTRU must wait to change a parameter value after an event (e.g., how long the WTRU must wait to change a parameter value since the last time the parameter value changed), how much certain parameter values can differ (e.g., an indication that all back-off timers must be within 2 seconds of each other), and/or whether the WTRU is allowed to change parameter values while roaming.

A WTRU may determine values of NAS layer parameters based on configuration information received from the network. The WTRU may determine values of NAS layer parameters and use the determined values of NAS layer parameters to influence the WTRU’s NAS layer behavior and interactions with the network. For example, the WTRU may receive information from the network that indicates what NAS parameters the WTRU is allowed to determine and information that describes to what degree the WTRU is allowed to change the NAS parameters. The methods of FIG. 3 and/or FIG. 4 illustrate examples of how the network may configure the WTRU with information that indicates what NAS parameters the WTRU is allowed to determine and information that describes to what degree the WTRU is allowed to change the NAS parameters.

Referring now to FIG. 5, an example method 500 for determining when to use WTRU-determined values of NAS layer parameters is illustratively depicted. FIG. 5 shows three examples. The first example, labeled Option A, illustrates a scenario in which the WTRU autonomously uses the WTRU-determined parameter value. The second example, labeled Option B, illustrates a scenario in which the WTRU must report the WTRU-determined parameter value to the network before autonomously using the WTRU-determined parameter value. The third example, labeled Option C, illustrates a scenario in which the WTRU must report the WTRU-determined parameter value to the network and must not use the WTRU-determined parameter value until the WTRU receives an indication from the network that the WTRU is permitted to use the WTRU-determined parameter value.

The example of FIG. 5 may occur after the example methods of FIG. 3 and/or FIG. 4. In other words, the example methods of FIG. 3 and/or FIG. 4 may be used to configure the WTRU with information about what parameter values the WTRU may determine and when the WTRU may apply the determined values. FIG. 5 illustrates how the WTRU may behave based on the configuration information received in the example methods of FIG. 3 and/or FIG. 4.

At 501 through 504, Option A is depicted. At 501, the WTRU may determine a NAS parameter value. The determination by the WTRU may be based on an AI/ML model. For example, the WTRU may have been configured with an AI/ML model and may have used the AI/ML model and input parameters to determine a NAS parameter value (e.g., a NAS timer).

At 502, the WTRU may determine to use the NAS parameter value. For example, if the determined NAS parameter value is a back-off timer, the WTRU may determine to use the back-off timer value the next time the WTRU needs to execute a procedure in which the back-off timer value is needed. Similarly, if the determined NAS parameter value is a registration timer, the WTRU may determine to use the registration timer value the next time the WTRU needs to execute a procedure in which the registration timer value is needed.

At 503, an event may be triggered based on the NAS parameter value that the WTRU determined at 501 and determined to use at 502. For example, if the NAS parameter value is a back-off timer value, then this step may involve the WTRU receiving a NAS rejection message in response to a NAS request message. Based on the NAS rejection message, the WTRU may determine to run a back-off timer for a duration that is approximately equal to the determined value. When the timer expires, the WTRU may determine to attempt to send the NAS request message again at 504. Similarly, if the NAS parameter value is a registration timer value, then this step may involve the WTRU entering an idle mode and/or state, and based on the WTRU being in the idle mode and/or state, running a registration timer for a duration that is approximately equal to the determined value. When the timer expires, the WTRU may determine to attempt to send a registration request to the network at 504.

At 504, based on the determination at 503, the WTRU may send a NAS message to the network. The NAS message may indicate to the network that the WTRU is using a WTRU-determined NAS layer parameter value. The NAS message may also indicate the determined value.

At 505 through 509, Option B is depicted. At 505, the WTRU may determine a NAS parameter value. The determination by the WTRU may be based on an AI/ML model. For example, the WTRU may have been configured with an AI/ML model and may have used the AI/ML model and input parameters to determine a NAS parameter value (e.g., a NAS timer).

At 506, the WTRU may send a NAS message to the network. The NAS message may indicate to the network that the WTRU is using a WTRU-determined NAS layer parameter value (e.g., the value that was determined at 505). The NAS message may also indicate the determined value. A benefit of this step is that the WTRU may inform the network of what parameter values the WTRU’s NAS layer is using.

At 507, the WTRU may determine to use the NAS parameter value. For example, the NAS parameter value that was determined at 505 may be a back-off timer. The WTRU may determine to use the determined back-off timer value the next time the WTRU needs to execute a procedure where the back-off timer value is needed. For example, the NAS parameter value that was determined at 505 may be a registration timer. The WTRU may determine to use the determined registration timer value the next time the WTRU needs to execute a procedure where the registration timer value is needed.

At 508, an event may be triggered based on the NAS parameter value that the WTRU determined at 505 and determined to use at 507. For example, if the NAS parameter value is a back-off timer value, then this step may involve the WTRU receiving a NAS rejection message in response to a NAS request message. Based on the NAS rejection message, the WTRU may determine to run a back-off timer for a duration that is approximately equal to the determined value. When the timer expires, the WTRU may determine to attempt to send the NAS request message again at 509. For example, if the NAS parameter value is a registration timer value, then this step may involve the WTRU entering an idle mode, and/or state, and based on the WTRU being in the idle mode and/or state, running a registration timer for a duration that is approximately equal to the determined value. When the timer expires, the WTRU may determine to attempt to send a registration request to the network at 509.

At 509, based on the determination at 508, the WTRU may send a NAS message to the network. The NAS message may indicate to the network that the WTRU is using a WTRU-determined NAS layer parameter value. The NAS message may also indicate the determined value.

At 510 through 515, Option C is depicted. At 510, the WTRU may determine a NAS parameter value. The determination by the WTRU may be based on an AI/ML model. For example, the WTRU may have been configured with an AI/ML model and may have used the AI/ML model and input parameters to determine a NAS parameter value (e.g., a NAS timer).

At 511, the WTRU may send a NAS message to the network. The NAS message may request that the network allow the WTRU to use a WTRU-determined NAS layer parameter value (e.g., the value that was determined at 510). The NAS message may also indicate the determined value. A benefit of this step is that the WTRU may make the network aware of what parameter values the WTRU’s NAS layer is using.

At 512, the WTRU may receive a NAS message from the network. The NAS message may indicate to the WTRU whether the WTRU is permitted to use the WTRU-determined NAS layer parameter value (e.g., the value that was determined at 510). A benefit of this step is that the network may control whether the WTRU uses the WTRU-determined value. If this message indicates that the WTRU is not permitted to use the WTRU-determined value, the message may also provide a network-determined value that should be used by the WTRU. Additionally, and/or alternatively, if this message indicates that the WTRU is not permitted to use the WTRU-determined value, the WTRU may continue using a value that was previously used.

At 513, based on the network indicating at 512 that the WTRU is permitted to use the value, the WTRU may determine to use the WTRU-determined NAS parameter value. Additionally, and/or alternatively, if the network indicated at 512 that the WTRU is not permitted to use the value and the network sent a value to the WTRU, the WTRU may determine to use the network-determined NAS parameter value. For example, the NAS parameter value that was determined at 510 may be a back-off timer. The WTRU may determine to use the determined back-off timer value the next time the WTRU needs to execute a procedure where the back-off timer value is needed. For example, the NAS parameter value that was determined at 510 may be a registration timer. The WTRU may determine to use the determined registration timer value the next time the WTRU needs to execute a procedure where the registration timer value is needed.

At 514, an event may be triggered based on the NAS parameter value that the WTRU determined at 510 and determined to use at 513. For example, if the NAS parameter value is a back-off timer value, then this step may involve the WTRU receiving a NAS rejection message in response to a NAS request message. Based on the NAS rejection message, the WTRU may determine to run a back-off timer for a duration that is approximately equal to the determined value. When the timer expires, the WTRU may determine to attempt to send the NAS request message again at 515. For example, if the NAS parameter value is a registration timer value, then this step may involve the WTRU entering an idle mode, and/or state, and based on the WTRU being in the idle mode and/or state, running a registration timer for a duration that is approximately equal to the determined value. When the timer expires, the WTRU may determine to attempt to send a registration request to the network at 515.

At 515, based on the determination at 514, the WTRU may send a NAS message to the network. The NAS message may indicate to the network that the WTRU is using a WTRU-determined NAS layer parameter value. The NAS message may also indicate the determined value.

A WTRU may determine when to trigger a registration update procedure. When the WTRU is registered to a serving network, the WTRU may enter an idle state. CM-IDLE is an example of an idle state. After the WTRU is in the idle state for a period of time, the WTRU may need to send a registration update message to the network. The WTRU may send the registration update message so that the network is aware that the WTRU is still present in the WTRU’s registration area and powered on.

A WTRU may use an AI/ML model to determine when to perform a registration update procedure. For example, the WTRU may have received an AI/ML model that is associated with the WTRU’s serving network (e.g., the PLMN ID of the serving network), and the AI/ML model may be used to determine a periodic registration timer. In other words, a periodic registration timer may be an output of the AI/ML model. Inputs to the AI/ML model may include default parameter values and default parameter ranges.

In this example, since the parameter is a periodic registration timer value, the default parameter value may be a default periodic registration timer value, and the default parameter range may represent a range of values that the output periodic registration timer value must adhere to.

The WTRU speed information may be an input to the AI/ML model. Including the WTRU speed information may be advantageous because a WTRU that is moving at a relatively fast speed may need to perform registration updates more frequently in order for the network to track the WTRU’s location more accurately.

The WTRU trajectory information may be an input to the AI/ML model. Including the WTRU trajectory information may be advantageous because a WTRU that is moving over a relatively large area may need to perform registration updates more frequently in order for the network to track the WTRU’s location more accurately.

Information about the WTRU’s history of accessing high-priority services may be an input to the AI/ML model. Including the WTRU’s history of accessing high-priority services may be advantageous because a WTRU that is likely to receive a page due to the initiation of a high-priority service may need to perform registration updates more frequently in order for the network to track the WTRU’s location more accurately. When the network is aware of the WTRU’s location, paging resources may be used more efficiently. IMS voice service is an example of a high-priority service.

Information about network conditions and/or state may be an input to the AI/ML model. For example, the network may broadcast information about network conditions and/or state. The information may be a value that is broadcast in a system information block (SIB). The information may be representative of congestion levels in the network.

Information about the WTRU’s history of transmitting uplink data may be an input to the AI/ML model. Including the WTRU’s history of transmitting uplink data may be advantageous because a WTRU that has long delays before it does any uplink data transmission may accordingly update its periodic registration timer to ensure that it does not perform too frequent periodic registrations between uplink data transmission intervals. Examples of the uplink data may include cellular IoT data transmissions by the WTRU. In other words, the periodic registration timer may be set to a value that is larger than the expected time between uplink transmissions, thus avoiding the need to execute many registration procedures.

Information about the WTRU’s unavailability due to software updates and/or scheduled maintenance may be an input to the AI/ML model. The information about the unavailability of the WTRU because of scheduled events may help the AI/ML model determine an optimal periodic registration timer that is negotiated with the network to ensure that it does not conflict with the WTRU being unavailable for uplink/downlink communication. For example, the AI/ML model may output a periodic registration timer value that is aligned with the unavailability of the WTRU, meaning that the WTRU may perform the periodic registration procedure at the end of the unavailability period.

The WTRU may periodically run the AI/ML model to obtain a periodic registration timer value. Each time the WTRU sends a NAS message to the network, the WTRU may include the periodic registration timer value that the WTRU most recently determined. The network may send a NAS message to the WTRU to confirm that the WTRU is permitted to use the determined periodic registration timer value.

For example, the WTRU may send a PDU session establishment request to the network. The PDU session establishment request may be a NAS-SM message that is carried in a NAS-MM message. The NAS-MM message may also carry the determined periodic registration timer value. The NAS-MM message that carries the PDU session establishment response message may also carry an indication of whether the determined periodic registration timer value should be used by the WTRU. For example, the NAS-MM message that carries the PDU session establishment response may include the determined periodic registration timer value as a way of indicating that the determined periodic registration timer value may be used by the WTRU.

For example, the NAS-MM message that carries the response may include no explicit indication as a way of indicating that the determined periodic registration timer value may be used by the WTRU.

For example, the NAS-MM message that carries the response may include a new periodic registration timer value as a way of indicating that the determined periodic registration timer value should not be used by the WTRU and that the new periodic registration timer value should be used by the WTRU.

Additionally, the NAS-MM message that carries the response may include new default parameter values and default parameter ranges that should be used by the WTRU the next time the AI/ML model is run.

In this example, after the PDU session establishment procedure is completed, the WTRU may send and receive data in the PDU session. Later, the WTRU may enter an idle state and configure a timer to run for a duration. If the determined periodic registration timer value was approved by the network, then the duration may be set to the determined periodic registration timer value. If the WTRU exits the idle state before the timer expires, then the timer will be reset and stopped. If the WTRU does not exit the idle state before the timer expires, then expiration of the timer will trigger the WTRU to send a periodic registration update message to the network.

Referring now to FIG. 6, an example method 600 for using an AI/ML model to determine a periodic registration timer value is illustratively depicted. FIG. 6 shows an example procedure for how a WTRU may use an AI/ML model to determine a periodic registration timer value.

At 601, the WTRU may be configured with AI/ML models. The WTRU may also be configured with PLMN ID(s), default parameter values, and default parameter ranges that are associated with the AI/ML model. The WTRU may receive event-based and/or network analytics-based updates for the AI/ML model and the default parameters.

At 602, the WTRU may determine and/or collect input values for an AI/ML model. Examples of input values may include WTRU speed information, WTRU trajectory information, information about the WTRU’s history of accessing high-priority services, information related to network conditions (e.g., information that is broadcast by the network), WTRU history of transmitting uplink data, and/or any WTRU scheduled software update and/or maintenance (e.g., the WTRU’s unavailability schedule).

At 603, the WTRU may determine to run the AI/ML model. The WTRU may determine to run the AI/ML model based on the values of the collected data and/or based on changes in the collected data values. Running the AI/ML model may result in the AI/ML model outputting a determined periodic registration timer value.

At 604, the WTRU may perform a NAS procedure. For example, the WTRU may determine to send a NAS request message to the network. Sending a NAS-MM message to the network that includes a NAS-SM request message may be an example of sending a NAS request message to the network. A PDU session establishment request may be an example of a NAS-SM message. The WTRU may include the determined periodic registration timer value in the NAS-MM message. The network may send a NAS response message to the WTRU. The response message may be a NAS-MM message that carries a NAS-SM message (e.g., a PDU session establishment accept message). The NAS-MM message may also include an indication of whether the WTRU is permitted to use the determined periodic registration timer value. The NAS-MM message received from the network that does not include any values for the periodic registration timer may be an indication that the WTRU is permitted to use the determined periodic registration timer value.

A PDU session modification request may be another example of a NAS-SM message that the WTRU may send to the network in the NAS-MM message. A PDU session modification accept may be another example of a NAS-SM message that the network may send to the WTRU in the NAS-MM message.

The NAS-MM message that is sent by the WTRU to the network may include no NAS-SM message. For example, the WTRU may send a service request message to the network, and the service request message may include the determined periodic registration timer value. The service accept message that is sent by the network to the WTRU may include an indication of whether the WTRU is permitted to use the determined periodic registration timer value.

The WTRU may receive a NAS message from the network, and the WTRU may send a NAS response message to the network. The NAS response message may include the determined periodic registration timer value. The WTRU may assume that it is permitted to use the determined periodic registration timer value unless the network sends a second NAS message to the WTRU to indicate that the WTRU is not permitted to use the determined periodic registration timer value.

Sending the determined periodic registration timer value to the network may have the benefit of making the network aware of the determined periodic registration timer value so that the network knows how long the WTRU should be anticipated to stay in idle mode. Thus, the network may know how long to wait before implicitly deregistering the WTRU.

At 605, the WTRU may perform procedures such as sending and receiving user plane data.

At 606, the WTRU may determine to enter an idle mode. For example, the WTRU may determine to enter the idle mode based on not receiving data for a period of time. When the WTRU enters idle mode, the WTRU may configure the registration timer based on the determined periodic registration timer value.

At 607, the WTRU may detect the expiration of the timer. In other words, the WTRU may detect that a period of time that is approximately equal to the periodic registration timer value has passed since entering the idle mode.

At 608, based on detecting the expiration of the timer, the WTRU may initiate a periodic registration procedure by sending a registration update request message to the network.

In examples, an AI/ML model may be used to determine the value of the registration timer T3502. The timer T3502 may be started by the WTRU at registration failure when the registration attempt counter is equal to the maximum allowed attempts (e.g., 5). Upon the expiration of the timer T3502, the WTRU may initiate the registration procedure if required. Thus, timer T3502 may be a timer that determines when registration is allowed. While the timer is running, registration may not be allowed. This timer may prevent the WTRU from continuously attempting to register. Thus, timer T3502 may be a type of reattempt and/or retransmission timer.

The T3502 timer is used as an example, but the logic for determining the registration timer value may be extended to any registration and/or other NAS procedure reattempt and/or retransmission timers (e.g., T3511 (registration retransmission timer), T3525 (service request reattempt timer), T3580 (PDU session establishment request retransmission timer), T3581 (PDU session modification request retransmission timer), T3582 (PDU session release request retransmission timer), T3586 (remote WTRU report retransmission timer)) and/or back-off timers (e.g., T3346 (back-off timer for mobility management), T3396 (back-off timer for session management)).

Inputs to the AI/ML model may include default parameter values and default parameter ranges. In this example, since the parameter may be a registration attempt timer value, the default parameter value may be a default registration attempt timer value (e.g., 6 minutes), and the default parameter range may represent a range of values that the output registration attempt timer value must adhere to.

Information about the WTRU’s history of accessing high-priority and/or mission-critical services may be an input to the AI/ML model. Including the WTRU’s history of accessing high-priority and/or mission-critical services may be advantageous because it may be used as an input to determine the timer duration. For example, a WTRU with a history of accessing high-priority services may wait for a shorter duration before reattempting registration compared to a WTRU that does not access high-priority services. Mission-critical voice, video, and/or data services, emergency services, and/or utility monitoring services may be examples of high-priority services.

Information about network conditions and/or state may be an input to the AI/ML model. For example, the network may broadcast information about network conditions and/or state. The information may be a value that is broadcast in a system information block (SIB). The information may be representative of congestion levels in the network.

Information about the WTRU’s history of transmitting uplink data may be an input to the AI/ML model. Including the WTRU’s history of transmitting uplink data may be advantageous because a WTRU that has long delays before it transmits uplink data (e.g., remote IoT sensors) may have a longer wait duration for the registration reattempt timer compared to a WTRU that needs to transmit data more frequently. Examples of uplink data may include cellular IoT data transmissions by the WTRU.

The WTRU may be configured with an AI/ML model that may be used to determine a T3502 value. Reception of a registration reject message may trigger the WTRU to determine to run the AI/ML model, and/or the WTRU may determine to run the AI/ML model based on the values of the collected data and/or based on changes in the collected data values. Running the AI/ML model may result in the AI/ML model outputting a determined T3502 value and an attempt count limit. If the WTRU does not receive a registration accept message before attempting to send a number of registration requests equal to the attempt count limit, then the WTRU may begin to run a timer. The timer may run for a duration that is equal to at least the determined T3502 value, and the WTRU may not attempt to send another registration request until the timer has expired.

In examples, a WTRU may be configured with AI/ML models. The configuration of the AI/ML models in the WTRU may depend on the support of this feature by the WTRU and the network, as well as the WTRU indicating its support to the network. When the WTRU uses an AI/ML model to determine a NAS parameter value, the WTRU may be configured with an AI/ML model from the network. The WTRU may be configured by the network with the AI/ML model before the WTRU uses the AI/ML model to determine a NAS parameter value.

Each AI/ML model may be associated with one or more PLMN ID(s). Each AI/ML model may be provided with the associated requirements related to data collection, associated functionality, model validity conditions, and WTRU capability. For example, data collection requirements may indicate how and when model training data needs to be collected and how it is used to train and/or update the model predictions. Similarly, model validity conditions may indicate the thresholds that should be met for a model to be applicable. AI/ML models may be used to determine parameter values. In other words, parameter values may be an output of AI/ML models. Timer values may be examples of parameter values.

The WTRU may receive the AI/ML models and the PLMN ID(s) associated with each AI/ML model via application layer signaling. For example, the WTRU may receive the AI/ML models from a server of the WTRU’s home network operator. The home network may determine what AI/ML models are associated with each PLMN ID based on roaming agreements with the home network’s roaming partners. The WTRU may also receive default parameter values and default parameter ranges associated with each AI/ML model and PLMN ID combination.

Additionally, and/or alternatively, the WTRU may receive the AI/ML models, PLMN ID(s), default parameter values, and/or default parameter ranges from the home network operator in a NAS container. The WTRU may receive AI/ML models, default parameter values, and/or default parameter ranges from a serving network in a NAS container. The WTRU may associate the received AI/ML models, default parameter values, and/or default parameter ranges with the PLMN ID of the serving network.

The WTRU may receive AI/ML models, default parameter values, and/or default parameter ranges from a serving network in an RRC message. The WTRU may associate the received AI/ML models, default parameter values, and/or default parameter ranges with the PLMN ID of the serving network. The WTRU may provide an acknowledgment to confirm the reception of an AI/ML model and/or upon the activation of the configured model for analytics in the WTRU. The acknowledgment message may include an indication of the action taken by the WTRU (e.g., reception success/failure and/or activation), and it may be sent as a NAS message, RRC message, and/or application layer message to the network.

The WTRU may receive updates related to an AI/ML model from the network (e.g., updated default parameters, updated default parameter ranges, updated AI/ML models, indications that an AI/ML model is invalid, and/or updated requirements for data collection for model training). The updates related to an AI/ML model may be received from a network function (e.g., NWDAF) based on long-term network analytics. If the received updates indicate that the AI/ML model is invalid, they may be associated with the time interval for which the model is invalid, and/or they may indicate that the network will perform the analytics and trigger selection.

The WTRU may be configured with different AI/ML models, each adapted for normal operations and/or "abnormal" operations (e.g., disaster roaming). Additionally, and/or alternatively, an AI/ML model may take as an input various operational conditions (e.g., disaster condition yes/no, signaling overload yes/no).

An AI/ML model may utilize one or more defined input parameters that the WTRU may provide to determine optimal parameters to be used for a NAS procedure. For example, the WTRU may provide the AI/ML model with the following input parameters: the message and/or procedure type (e.g., registration, PDU session establishment and/or modification), the PLMN ID, the WTRU location (e.g., geolocation, tracking area, and/or cell ID), and/or the time of day.

For example, in a disaster roaming and/or congestion scenario, the WTRU may provide the AI/ML model (e.g., using an AI/ML model adapted for disaster roaming handling) with one or more PLMN ID(s) (e.g., current PLMN, disaster roaming PLMN ID, and/or a list of allowed PLMN IDs including a PLMN ID under disaster conditions), current location, default wait range values, and/or a cause code for a network rejection message. The WTRU may obtain from the model one or more wait range values and/or timer values adapted to the WTRU context. These values may be used by the WTRU to determine when to initiate the next NAS procedure (e.g., registration and/or service request) at an optimal time considering both WTRU/user and network requirements (e.g., minimizing delay for the WTRU to perform the procedure while avoiding signal overload in the network).

Changing the configuration of an NAS layer parameter may impact the configuration of the RAN layer. For example, changing the length of the active timer to a smaller value may necessitate changing the value of the eDRX cycle length to a smaller value.

When the network configures the WTRU with information about what NAS layer parameters the network permits the WTRU to determine, the network may indicate to the WTRU that it should indicate to the RAN (e.g., the base stations) when the WTRU changes certain NAS layer parameters. For example, the network may configure the WTRU with this information at 302 and/or 303c of FIG. 3, and/or at 401 and/or 403c of FIG. 4. In other words, the network may send an indication to the WTRU so that the WTRU knows that it should send an RRC message to the network so that the base station is provided with the new WTRU-determined NAS layer parameter.

As described at 504 and/or 506 of FIG. 5, the WTRU may send a NAS message, and the NAS message may indicate the WTRU-determined NAS layer parameter value to the network. NAS messages may be sent inside of an RRC message. The WTRU may provide the WTRU-determined NAS layer value to the base station by including the WTRU-determined NAS layer value in the RRC message that carries the NAS message. The WTRU may determine to include the WTRU-determined NAS layer parameter value based on the indication from the network that it should indicate to the RAN (e.g., the base station) when the WTRU changes the NAS layer parameter.

As described at 511 of FIG. 5, the WTRU may send a NAS message, and the NAS message may indicate the WTRU-determined NAS layer parameter value to the network. As described at 512 of FIG. 5, the WTRU may receive a NAS message from the network that indicates that the WTRU is permitted to use the WTRU-determined parameter. The message that is used to send the NAS message to the RAN (e.g., an N2 message) may also be used to provide the WTRU-determined NAS layer parameter value to the RAN. Additionally, and/or alternatively, the combination of the reception of the downlink NAS message at 512 and the configuration information that was received from the network may trigger the WTRU to send an RRC message to the RAN (e.g., the base station) to provide the NAS layer parameter value to the RAN.

In examples, a WTRU may include a graphical user interface (GUI). The GUI may be an application that runs in the terminal equipment (TE) part of the WTRU. The WTRU may allow the user of the WTRU to disable WTRU determinations, disable AI/ML determinations, and/or put the WTRU into a low-power mode. Since using an AI/ML model to make determinations may cause the WTRU to consume more power and thereby lead to shorter battery life, it may be advantageous for a user of the WTRU to disable the feature.

If the user of the WTRU changes a GUI setting that triggers the WTRU to disable the feature, the WTRU may be triggered to send the message at 301 of FIG. 3. The message at 301 of FIG. 3 may indicate that the WTRU is not capable of making any independent NAS layer parameter determinations and/or not capable of making certain independent NAS layer parameter determinations. The message may indicate that the WTRU’s lack of capability is temporary.

1. A wireless transmit/receive unit (WTRU) comprising:
a processor configured to:
send a first message to a network, the first message indicating that the WTRU is capable of determining a value of at least one Non-Access Stratum (NAS) layer parameter;
receive configuration information from the network, wherein the configuration information indicates whether the WTRU is permitted to determine the value of the NAS layer parameter and indicate whether the WTRU is to report the value of the NAS layer parameter to the network prior to utilizing the value of the NAS layer parameter;
determine, based on at least one condition associated with the WTRU, the value of the NAS layer parameter;
apply the value of the NAS layer parameter to at least one NAS procedure performed by the WTRU; and
send a second message to the network, wherein the second message comprises one or more of an indication of the value of the NAS layer parameter or an indication that the WTRU has applied the value of the NAS layer parameter.

2. The WTRU of claim 1, wherein the processor is configured to utilize the value of the NAS layer parameter in one or more of a NAS mobility management procedure, a NAS session management procedure, or a NAS procedure during disaster roaming.

3. The WTRU of claim 1, wherein the value of the NAS layer parameter comprises a timer value, wherein the timer value comprises one or more of:
a periodic registration timer;
a back-off timer; or
a Protocol Data Unit (PDU) session establishment retransmission timer.

4. The WTRU of claim 1, wherein the processor is further configured to send a third message to the network prior to applying the value of the NAS layer parameter, wherein the third message indicates the value of the NAS layer parameter.

5. The WTRU of claim 1, wherein the processor is configured to receive a response message from the network before applying the value of the NAS layer parameter, wherein the response message comprises an indication of whether the WTRU is permitted to apply the value of the NAS layer parameter.

6. The WTRU of claim 1, wherein the processor is configured to determine the value of the NAS layer parameter using an Artificial Intelligence/Machine Learning (AI/ML) model.

7. The WTRU of claim 6, wherein the processor is configured to determine AI/ML model inputs prior to determining the value of the NAS layer parameter, wherein the AI/ML model inputs comprise at least one of WTRU speed, WTRU location, historical access to high-priority services, or network conditions.

8. The WTRU of claim 1, wherein the configuration information comprises an indication of how the WTRU is permitted to modify the value of the NAS layer parameter; and
wherein the indication of how the WTRU is permitted to modify the value of the NAS layer parameter comprises an indication of a maximum allowable percentage change from a network-configured value of the NAS layer parameter.

9. The WTRU of claim 1, wherein the at least one condition comprises one or more of a WTRU speed, a WTRU location, historical access to high-priority services, or network conditions.

10. The WTRU of claim 1, wherein the processor is configured to determine to exit an idle mode based on the value of the NAS layer parameter and to initiate a registration update procedure upon exiting the idle mode.

11. A method implemented by a wireless transmit/receive unit (WTRU), the method comprising:
sending a first message to a network, the first message indicating that the WTRU is capable of determining a value of at least one Non-Access Stratum (NAS) layer parameter;
receiving configuration information from the network, wherein the configuration information indicates whether the WTRU is permitted to determine a value of the NAS layer parameter and indicating whether the WTRU is to report the value of the NAS layer parameter to the network prior to utilizing the value of the NAS layer parameter;
determining, based on at least one condition associated with the WTRU, the value of the NAS layer parameter;
applying the value of the NAS layer parameter to at least one NAS procedure performed by the WTRU; and
sending a second message to the network, wherein the second message comprises one or more of an indication of the value of the NAS layer parameter or an indication that the WTRU has applied the value of the NAS layer parameter.

12. The method of claim 11, further comprising utilizing the value of the NAS layer parameter in one or more of a NAS mobility management procedure, a NAS session management procedure, or a NAS procedure during disaster roaming.

13. The method of claim 11, wherein the value of the NAS layer parameter comprises a timer value, wherein the time value comprises one or more of:
a periodic registration timer;
a back-off timer; or
a Protocol Data Unit (PDU) session establishment retransmission timer.

14. The method of claim 11, further comprising sending a third message to the network prior to applying the value of the NAS layer parameter, wherein the third message indicates the value of the NAS layer parameter.

15. The method of claim 11, further comprising receiving a response message from the network before applying the value of the NAS layer parameter, wherein the response message comprises an indication of whether the WTRU is permitted to apply the value of the NAS layer parameter.

16. The method of claim 11, further comprising determining the value of the NAS layer parameter using an Artificial Intelligence/Machine Learning (AI/ML) model.

17. The method of claim 16, further comprising determining AI/ML model inputs prior to determining the value of the NAS layer parameter, wherein the AI/ML model inputs comprise at least one of WTRU speed, WTRU location, historical access to high-priority services, or network conditions.

18. The method of claim 11, wherein the configuration information comprises an indication of how the WTRU is permitted to modify the value of the NAS layer parameter; and
wherein the indication of how the WTRU is permitted to modify the value of the NAS layer parameter comprises an indication of a maximum allowable percentage change from a network-configured value of the NAS layer parameter.

19. The method of claim 11, wherein the at least one condition comprises one or more of a WTRU speed, a WTRU location, historical access to high-priority services, or network conditions.

20. The method of claim 11, further comprising determining to exit an idle mode based on the value of the NAS layer parameter and initiating a registration update procedure upon exiting the idle mode.
